(19) United States
(12) Patent Application Publication
(10) Pub. No.: US 2008/0271694 A1
(43) Pub. Date: Nov. 6, 2008

(54) Limited travel hydraulic lifter and methods of assembly and use thereof

(75) Inventor: Pual Brothers, Memphis, TN (US)

Correspondence Address: ARENT FOX LLP, 1050 CONNECTICUT AVENUE, N.W., SUITE 400, WASHINGTON, DC, 20036, US

(73) Assignee: Competition Cams, Inc.

(21) Appl. No.: 11/907,044

(22) Filed: Oct. 9, 2007

Related U.S. Application Data
(60) Provisional application No. 60/849,797, filed on Oct. 6, 2006.

(51) Int. Cl. F01L 1/245; F01L 1/14; B23P 15/00

(52) U.S. Cl. 123/90.55; 123/90.48; 29/888.03

(57) ABSTRACT

A travel limited plunger for a hydraulic lifter for, among other purposes, use in racing and/or other high performance applications. In one variation, an existing retaining clip is replaced by a heavy duty retainer and a precisely sized spacer is inserted between the retainer and the plunger to limit travel of the plunger. In a second variation, the existing retaining clip is removed, a retaining groove is formed (e.g., by machining) within the interior of the lifter at a position located so as to allow a retainer inserted therein to limit travel of the plunger to a predetermined distance.

### RELATED APPLICATION

This application claims the benefit of U.S. Provisional Application Ser. No. 60/849,797 filed Oct. 6, 2006, titled “Limited Travel Hydraulic Lifter and Method of Use Thereof,” which is incorporated in its entirety by reference herein.

### BACKGROUND OF THE INVENTION

1. Field of the Invention

The present invention relates to the field of hydraulic lifters for combustion engine applications and methods of assembly and use thereof, and in particular to hydraulic lifters having travel limiting inserts and enhanced retainers and/or relocated enhanced retainers for a lifter piston especially for racing and/or other high performance applications.

2. Background of the Technology

There is an unmet need in the prior art for limited travel hydraulic lifters for, among other things, racing and/or other high performance applications.

### SUMMARY OF THE INVENTION

Embodiments of the present invention provide features for limiting travel of a plunger in a hydraulic lifter for, among other purposes, use in racing and/or other high performance applications.

In a first exemplary embodiment, a standard (e.g., wire) retaining clip of a hydraulic lifter is replaced by a heavy duty retainer, and a precisely sized spacer is inserted between the retainer and the plunger of the hydraulic lifter, so as to limit travel of the plunger to a predetermined range of travel distance.

For assembly in accordance with of the first embodiment, for example, the standard retaining clip is removed, the plunger is forced to a minimal travel position of the plunger, the spacer is inserted, and the retainer is installed to retain the spacer and the plunger. The spacer thereby effectively removes the previously available distance of travel of the plunger corresponding to the width of the spacer, and the retainer ensures retention of the plunger and the spacer, particularly in high stress applications, such as during racing and/or other high performance use.

In a second exemplary embodiment, the existing retaining clip is removed, a retaining groove is formed (e.g., by machining) within the interior of the lifter at a position determined to allow the retainer to be located so as to limit travel of the plunger to a predetermined distance, and the retainer is inserted into the newly formed retaining groove, thereby so limiting plunger travel.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 is a first cross-sectional view of an exemplary related art hydraulic lifter;

FIG. 2 shows a cross-sectional representative view of typical piston travel for the hydraulic lifter of FIG. 1; and

FIG. 3 presents a cross-sectional representative view of a hydraulic lifter in accordance with an illustrative first embodiment of the present invention.

### DETAILED DESCRIPTION

A typical unmodified hydraulic lifter of the related art includes a tappet body and a traveling plunger piston housed within the tappet body. In operation, such hydraulic lifters are situated so as to transmit motion from a cam on a camshaft to a valve in a combustion engine. Exemplary prior art hydraulic valve features and operation are shown and described in U.S. Pat. No. 2,145,484 to C. E. Johnson, U.S. Pat. No. 2,175,467 to C. E. Johnson, U.S. Pat. No. 3,509,858 to E. W. Scheibe, et al., and U.S. Pat. No. 4,223,648 to Pozniak, et al., the entirety of each of which is incorporated herein by reference.

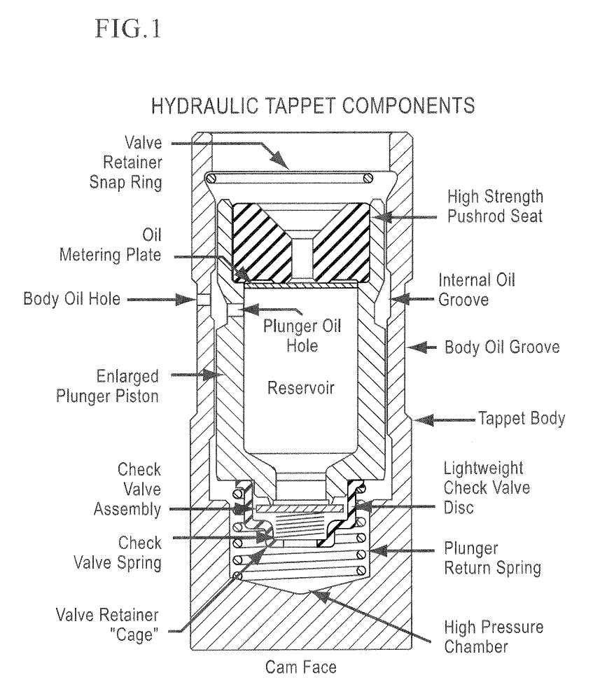

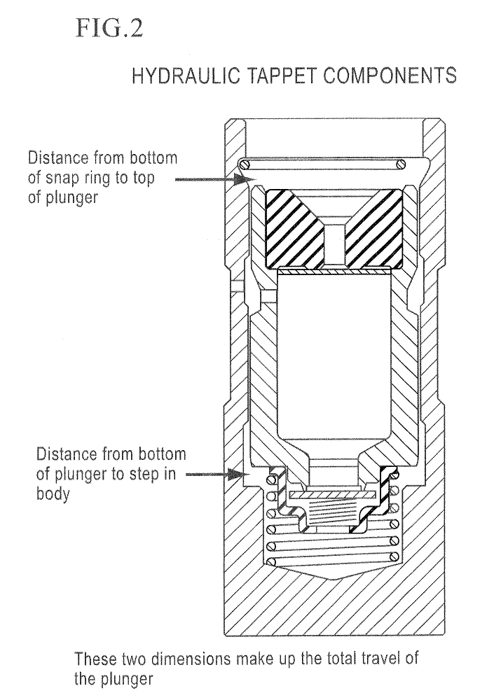

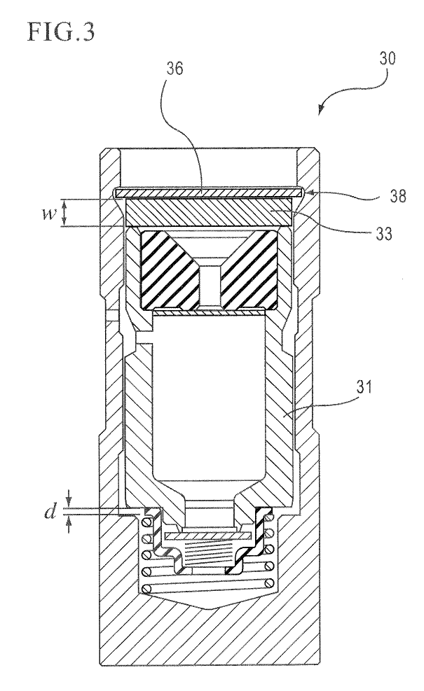

FIG. 1 shows an exemplary unmodified hydraulic lifter of the related, with various components indicated. While FIGS. 1 and 2 show a flat faced hydraulic lifter, the elements shown are generally equally applicable to roller faced lifter applications. For example, while an illustrative embodiment of the present invention is shown in FIG. 3 for a flat faced hydraulic lifter application, this embodiment is generally applicable to roller faced lifters, as well.

The total travel of the plunger piston (also interchangeably referred to herein as the “plunger”) inside a hydraulic lifter is typically the sum of the distances from the bottom of a retaining snap ring at the top of the lifter to the top of the plunger plus the distance from the bottom of the plunger to the step in the body at the bottom of the tappet body, as shown in FIG. 2. The travel of the plunger within the hydraulic lifter is used for such purposes as to make up for performance impacts of thermal expansion, manufacturing differences, wear, etc. Among other advantages, use of a hydraulic lifter in combustion engine applications typically simplifies adjustment of the valves, because the valves must only be adjusted to an accuracy within the range of the travel of the plunger. Then, in operation, the hydraulic aspects of the lifter essentially “self-adjust” to a steady state position.

Operation of the above exemplary unmodified hydraulic lifters of the related art typically works well for most combustion engine applications, so long as the combustion engine is being operated in its original design for normal operation. However, in racing and/or other high performance applications (e.g., high engine revolution per minute (RPM) engine applications), for example, several factors can cause changes in the operation of the lifter, including the following.

### High Spring Loads

Extreme high valve spring loads, which are common in racing and/or other high performance applications, for example, can cause the oil pressure in the lifter to be overcome, forcing the plunger toward the bottom of its travel (as shown in FIGS. 1 and 2). As the cam rotates and the valve closes, these forces decrease, but the plunger in the lifter is depressed (due to travel of the plunger toward the bottom, as shown in FIGS. 1 and 2), causing excessive clearance in the valve train. This action can create a great deal of noise, and the extra clearance produced can cause failure of the pushrod, rocker, or even the valve. Eventually the plunger will adjust itself within an operation cycle, but as soon as the next cycle of engine operation occurs, the excessive clearance action repeats.

### High Lifter Acceleration

One difference between a racing and/or other high performance cam and a standard cam is how quickly the cam accelerates the lifter. In racing and/or other high performance engine applications, for example, as the cam begins to move, the forces produced on the plunger via the cam are much greater than was typically originally designed for standard condition engine operation. This high force causes similar to as high spring pressures discussed above, and the plunger is initially forced to the bottom of its travel (as shown in FIGS. 1 and 2). When the initial forces decrease as operation continues, excess clearance in the system occurs, causing noise and potential part failure.

### High RPM Lifter Toss

When engine speed increases, such as in racing and/or other high performance applications, it is common for the lifter to “toss” over the nose of the cam. This “toss” action in itself is not a problem. However, if the plunger in the lifter was initially depressed too far, such as may occur as a result of high spring loads and/or high lifter acceleration, at the point when the lifter “tosses,” no force at all is applied to the plunger by the cam, and the oil pressure inside the lifter forces the plunger all the way to the top of its travel (as shown in FIGS. 1 and 2). Among other things, this action can be damaging because, when the lifter returns to contact with the cam the plunger (after the “toss”), the lifter is typically incorrectly positioned, and, as a result, the valve will not properly contact the seat in the head, in turn causing extreme loss of power. Also, when the plunger hits the retaining clip (which, for example, may be a wire clip in the related art), the force of the impact can cause the clip to be expelled from the lifter and, for example, to be displaced within the engine compartment, while removing the limitation on plunger motion provided by the clip.

Although one of the benefits of the standard hydraulic lifter is the range of travel, which makes the valves easy to adjust, this benefit is generally unimportant in racing and/or other high performance applications, for example. The user in these applications typically accepts difficulty in adjusting the valves, so long as power increase can be obtained. Therefore, there is generally little problem in such applications in severely limiting the travel of the plunger within the lifter. In order to meet the rules of sanctioning bodies in racing, and/or to further ensure that a hydraulic lifter used in racing and/or other high performance applications functions in a hydraulic manner for performance or other purposes, some plunger travel may need to be retained. However, to improve performance in such applications, a need remains to limit greatly the travel of the plunger, yet to ensure that failure of the clip and other negative high stress effects (e.g., those resulting from high RPM operation) are avoided.

Several existing designs are available in the market to reduce travel in a hydraulic lifter. The most common existing design uses a stock lifter, which is typically inexpensive and generally readily available. A stamped steel retaining clip is used to replace the typical wire clip used at the top of the plunger. This stamped clip is designed so as to locate the plunger about halfway down its travel. This approach works fairly well, until operation reaches a sufficiently high RPM to cause the top of the plunger to displace the stamping from the retaining groove in the tappet body, which in turn allows the plunger to travel beyond the intended limit. In general, this design simply is not strong enough to hold the plunger in place at high RPMs typical in some racing and/or other high performance applications.

The present invention overcomes the above identified problems, as well as others, so as to enhance the performance of a hydraulic valve lifter in, among other things, high RPM and/or racing engine applications. Overcoming these problems for hydraulic lifters in racing applications is particularly needed because several sanctioning bodies for racing require the use of hydraulic lifters.

In the lifter in accordance with an exemplary embodiment of the present invention, as shown in FIG. 3, to overcome one or more of the problems above, as well as others, the existing wire clip of a lifter 30 is removed, the plunger 31 is located at a predetermined distance (e.g., for illustrative purposes, 0.040″-0.050″ may be the selected distance, although any appropriate distance, including distances less than 0.040″ and more than 0.050″ may be used, as suitable for a given application) or less from the bottom of the travel, and a machined or otherwise appropriately sized spacer 33 (e.g., having a width w) is installed at the top of the piston, as shown in FIG. 3, so as to remove any remaining possible travel of the piston, thereby limiting travel to the predetermined distance d (e.g., 0.040″-0.050,″ or any other selected appropriate distance) remaining available. The standard wire clip is replaced by a much heavier duty retainer 36 (e.g., a “Tru-Arc” retaining clip, such as made by Truarc Company LLC of Millburn, N.J.), retained in the existing retaining groove 38, which ensures that the piston remains retained in the tappet body, even in high stress conditions (e.g., when the engine is operated at very high RPMs).

A result for this embodiment of the present invention is a lifter that has preselected limited travel (e.g., 0.040″-0.050,″ or any other selected appropriate distance) with a retaining feature that will not fail under racing and/or other high performance conditions, for example. The problems with engine performance and failure that were discussed with standard lifters are alleviated because the total travel in the lifter is reliably limited to an amount that is not harmful.

Alternatively to the above approach, the retaining groove can be relocated (e.g., at a location corresponding to the lower end of the spacer 33 of FIG. 3) to allow the stronger retaining clip alone to limit the travel of the piston, without the necessity of using a spacer. However, since standard lifters are made in extremely high volumes, such that the prices of these lifters is relatively low, compared to the cost of custom producing or custom modifying, by forming appropriate grooves, such relatively low volume lifters for racing applications, use of a spacer and a standard lifter may provide a simpler and less expensive way to address the problems identified above, as well as others, for relatively low volume needs. Higher volume needs may justify this alternative approach.

Example embodiments of the present invention have now been described in accordance with the above advantages. It will be appreciated that these examples are merely illustrative of the invention. Many variations and modifications will be apparent to those skilled in the art.

1. A travel limited hydraulic lifter, comprising:
a hydraulic lifter body having a plunger receiving opening and a retaining groove located within the plunger receiving opening;
a plunger received within the plunger receiving opening of the hydraulic lifter body;
a retainer located within the retaining groove; and
a spacer sandwichably located between the located retainer and the plunger, within the plunger receiving opening.

2. The lifter of claim 1, wherein the retainer is suitable for heavy duty use.

3. The lifter of claim 1, wherein in the retainer retains the plunger and spacer within the plunger receiving opening of the hydraulic lifter body during high stress operation.

4. The lifter of claim 3, wherein the high stress operation includes operation within an engine during racing or other high performance operation.

5. The lifter of claim 1, wherein the plunger has a travel within the plunger receiving opening, and wherein the retainer and the spacer limit the travel of the plunger.

6. The lifter of claim 5, wherein the spacer is sized so as to limit the travel of the plunger to a predetermined distance.

7. The lifter of claim 6, wherein the predetermined distance is between about 0.40 and 0.50 inches.

8. The lifter of claim 6, wherein the predetermined distance is less than 0.40 inches.

9. The lifter of claim 6, wherein the predetermined distance is more than 0.50 inches.

10. The lifter of claim 1, wherein the lifter retains hydraulic operation during travel of the plunger.

11. The lifter of claim 1, wherein the lifter prevents excessive clearance in a valve train of an engine in which the lifter is installed.

12. The lifter of claim 1, wherein the lifter prevents significant lifter toss in an engine in which the lifter is installed.

13. The lifter of claim 1, wherein the lifter is a flat faced lifter.

14. The lifter of claim 1, wherein the lifter is a roller faced lifter.

15. A travel limiting mechanism for use with a hydraulic lifter, wherein the hydraulic lifter includes a hydraulic lifter body having a plunger receiving opening and a retaining groove located within the plunger receiving opening, and a plunger received within the plunger receiving opening of the hydraulic lifter body, the travel limiting mechanism comprising:
a retainer retainable in the retaining groove; and
a spacer sandwichably locatable between the retained retainer and the plunger within the plunger receiving opening;
wherein the spacer is sized so as to limit the travel of the plunger to a predetermined distance.

16. A travel limited hydraulic lifter, comprising:
a hydraulic lifter body having a plunger receiving opening;
a plunger received within the plunger receiving opening of the hydraulic lifter body;
a groove formed in the plunger receiving opening; and
a retainer located within the formed groove in the plunger receiving opening;
wherein the groove is formed at a location such that the retainer limits travel of the plunger to a predetermined distance.

17. The lifter of claim 16, wherein the retainer is for heavy duty use.

18. A method for assembling a travel limited hydraulic lifter, wherein the hydraulic lifter has a body, a plunger receiving opening in the body, a retaining groove located within the plunger receiving opening, and a plunger receivable within the plunger receiving opening, the received plunger being capable of travel within the plunger receiving opening, the method comprising:
removing a first retainer from the retaining groove;
inserting a spacer having a predetermined size into the plunger receiving opening so as to abuttably affect the travel of the plunger; and
inserting a second retainer into the retaining groove;
wherein the travel of the plunger within the plunger receiving opening is limited as a function of the predetermined size of the spacer.

19. The lifter of claim 18, wherein the second retainer is for heavy duty use.
